(19) United States
(12) Patent Application Publication
(10) Pub. No.: US 2003/0105193 A1
(43) Pub. Date: Jun. 5, 2003

(54) Thermoplastic insole

(76) Inventor: Gerald Wang, Taipei (TW)

Correspondence Address: RABIN & BERDO, P.C., Suite 500, 1101 4th Street, N.W., Washington, DC, 20005, US

(21) Appl. No.: 10/002,172

(22) Filed: Dec. 5, 2001

(51) Int. Cl. C08J 3/00; A43B 7/22; B29D 22/00; B29D 23/00; C08K 5/00; C08L 1/00; B32B 1/08; B65D 1/00; F16L 1/00

(52) U.S. Cl. 524/81; 36/91; 428/36.5

(57) ABSTRACT

The invention of Thermoplastic Insole is orderly composed of polyethylene layer, thermoplastic layer and surface-clothing layer from bottom to the top. Meanwhile, the thermoplastic layer is produced and, proportionately blended by vinyl acetate, thermoplastic rubber, plasticizer and processing agent. User may use the foot to press on such insole while it turns into soft status after heating, furthermore, the shape will form after cooling and perfectly fit the user's foot, hence the individual insole leads highly comfortable feeling.

### BACKGROUND OF THE INVENTION

The invention of Thermoplastic Insole which is with the plasticity's property, the insole will thus become soft after heating, user can then step and press on it so as to form the shape of his (her) own foot after cooling. Consequently, it will bring highly comfortable feeling to user due to the individual insole.

For the time being, the shoes makers normally produce the shoes by means of shoe molding, it will never provide with the individually proprietary shoes so as to fit different user's foot shape. Please note the user wearing new shoes often feels too tight or skin injured, it is because the feet load the whole body's weight during walking, in addition, the feet must bear the pressure as well as friction in a long time which will lead thicker cuticle and cause clavus as well as callus. In serious case, both of hallux valgus and the irritated will occur. Once the foot's reaction happened, it could probably affect not only foot but also knee joint as well as hip joint, even, back pain could therefore induce.

In order to solve the above problem, we just need to trim the insole whose comfort will be accordingly improved. At present, the methods being applied to adjustable insole include installation of pad of inner wedge or outer wedge, toe pad, heel pad, and arch pad. Yet the above foot auxiliary needs to match with the shoes' style and user's shape for further purchase, it just causes the inconvenience.

In view of the inconvenience, I myself make my every endeavor as to research according to several years of related experiences, the invention is finally available. Thus, the invention is to provide one kind of Thermoplastic Insole, users can preheat the insole, then, step and press on the insole by foot, the ideally individual foot shape's insole can be produced and obtained. It provides the better comfort and good support by means of the insole and, improve the long term's pressure and abrasion of suffering in the shoes, so, the related illness can be avoided.

Thus, the major purpose of the invention is to provide one sort of Thermoplastic Insole, and, the plasticity after heating can be applied to produce the individual foot shape's insole and provide the better comfort.

In addition, another purpose for the invention which will provide the method of producing and forming subject to above Thermoplastic Insole.

### SUMMARY

In order to achieve the above goal, the invention comes true by the way like this: Thermoplastic Insole is orderly composed of polyethylene layer, thermoplastic layer and surface-clothing layer from bottom to the top. Would stress the feature: the thermoplastic layer after heating which will provide the plasticity, and it will be applied to produce the perfect foot shape for the individual user.

### BRIEF DESCRIPTION OF THE DRAWINGS

FIG. 1 is a separated structure of Thermoplastic Insole.

FIG. 2 is a cutaway structure of Thermoplastic Insole.

FIG. 3 is a flow chart of processing of Thermoplastic Insole.

FIG. 4 is a flow chart of plasticity of Thermoplastic Insole.

### LIST OF REFERENCE NUMBERS

1—Plasticized Insole

11—Polyethylene Layer

12—Thermoplastic Layer

121—Blending & Heating

122—Injection

123—Cooling & Shaping

13—Surface-clothing Layer

14—Hot Coating

15—Cooling

21—Heat Insole

22—Foot Molding of Pressing

23—Cooling & Shaping

### DETAILED DESCRIPTION

I would like to draw your attention as to further realize the particular structure and function of the invention, hence submit the following instance as well as diagram, and will describe in detail as below:

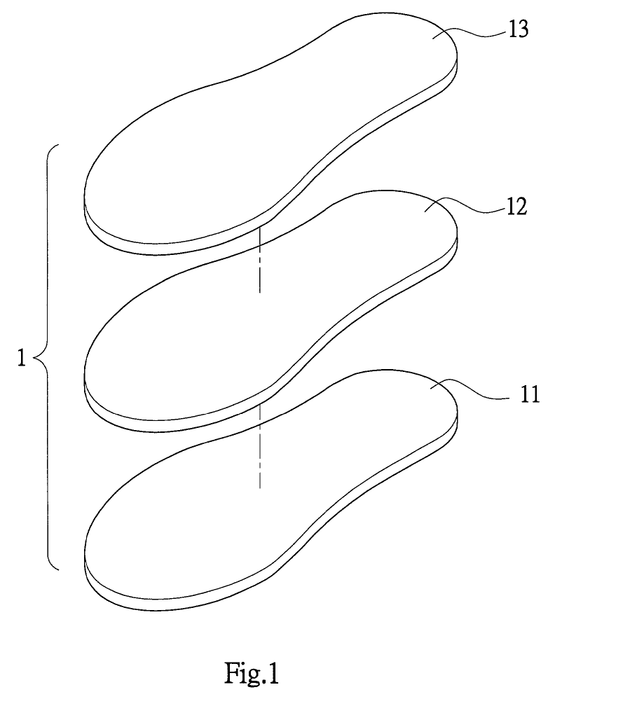

Please refer to FIG. 1, it's a diagram of separated structure of inventive Thermoplastic Insole, such as Polyethylene layer—11, thermoplastic layer—12, and surface-clothing layer—13, and which are orderly composed from bottom to the top.

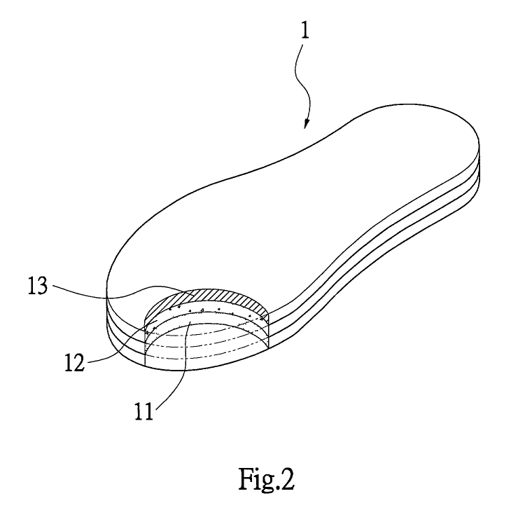

Please refer to FIG. 2, it is an cutaway structure of the inventive Thermoplastic Insole, kindly note the polyethylene layer—11 is applied to support the foot's loading from all of body's weight and, avoid the shape changed as well; thermoplastic layer—12 is with the property of plasticity which will become soft after heating; surface-clothing—13 is with the excellent function such as sweat absorption, deodorization, anti-bacteria, and slight anti-slipperiness.

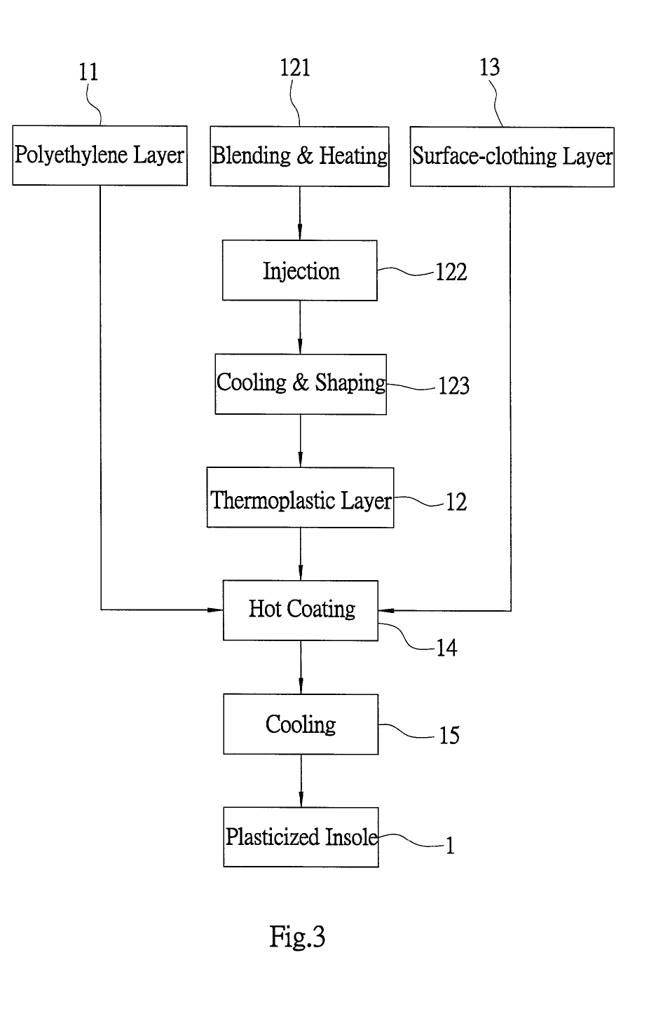

Please refer to FIG. 3, it is the flowchart of processing of the invention, would breakdown the following 3 major stages:

<Stage—1> Processing of Thermoplastic Layer—12:

It will be blended by vinyl acetate, thermoplastic rubber, plasticizer, processing agent, after heating, the liquid form—121 occurs, it is further being injected into form—122, after cooling, the shape is being fixed—123; the best blending ratio to be as below: ethyl acetate: 50%, thermoplastic rubber: 30%, plasticizer: 10%, processing agent: 10%.

<Stage—2>Hot Coating—14: To put the thermoplastic layer—12 on the polyethylene layer—11 which has been heated and pressed, then, lay surface-clothing layer—13 on the thermoplastic layer—12, and heat it at 100˜120° C. for 1 minute, it will make polyethylene layer, thermoplastic layer and surface-clothing layer heatedly coated and form a true one.

<Stage—3>Cooling—15: Afterwards, the coated one will be cooled at 0˜4° C. for 2 minutes, and the thermoplastic insole—1 will be obtained. With regard to the above thermoplastic layer, the vinyl acetate is with the super plasticity, the recipe's ratio can be the range of 50˜60%; thermoplastic rubber is a highly hydrated material, it's not only with good weatherproof and aging but also super plasticity, the ratio of recipe would be 20˜30%; plasticizer is with the quality of resisting color change, and higher the plasticity; processing agent can accelerate and enable the dissolution.

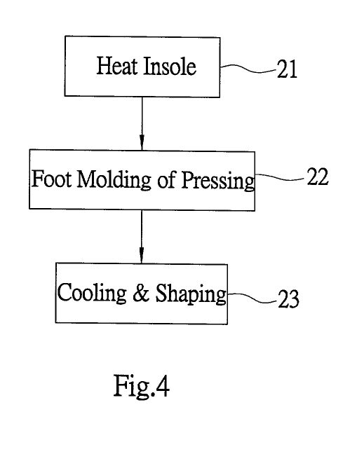

Please refer to FIG. 4, which is a flow chart of plasticity of Thermoplastic Insole of the invention, will heat insole—21 and become soft status, meanwhile, the user step and press on the insole by foot, then foot molding forms—22, after shape cooled—23, the individual insole complied with user's foot is being produced. As for the heating method, would recommend to cover the insole by plastic film or plastic bag, then, dip it into 60˜80° C. hot water, alternatively, the dry-heat of processing by oven or microwave is available, yet, the caution to be under 90° C. during heating.

The invention—Thermoplastic Insole has been authorized to Taiwan Footwear Research Institute as to process the hardness test (see as the enclosed—1): the hardness showed is 50˜55 at 10˜40° C., hence the insole is rather hard; the hardness will drop to 35 while the temperature raises up to 60° C., the sole appears slightly soft and leaves the precious mark; the hardness will drop to 31 while the temperature raises up to 70° C0, the sole has become soft and leaves the obviously precious mark.

With the above description, the invention—Thermoplastic Insole is orderly composed of polyethylene layer, thermoplastic layer and surface-clothing layer from the bottom to the top, simultaneously, the thermoplastic layer is produced and, proportionately blended by vinyl acetate, thermoplastic rubber, plasticizer, and processing agent, after preheating, the insole will turn to soft, user can step and press on the insole so as to produce suitable sole to fit individual foot, it thus provide the better comfort and, improve the long term's suffering on foot due to pressure and abrasion, the related illness can be avoided further. It is did with the feature of innovation as well as progression, and comply with the requirement of pattern of invention, hence, would like to apply the inventive pattern accordingly.

What is claimed is:

1. One sort of thermoplastic insole is orderly composed of polyethylene layer, thermoplastic layer and surface-clothing layer from the bottom to the top, meanwhile, the thermoplastic layer is produced and, proportionately blended by vinyl acetate—50%, thermoplastic rubber—30%, plasticizer—10% and processing agent. After heating, the insole's plasticity can be applied in order to produce the individually suitable insole, and provide the better comfort.

2. The Thermoplastic Insole as claimed in claim 1, wherein the thermoplastic layer is composed as below:
vinyl acetate: component range 50%˜60%
Thermoplastic rubber: component range 20%˜30%
Plasticizer: 10%
Processing agent: 10%, it will be blended by ratio based on 100% and, produced by heating.

3. The processing method of Thermoplastic Insole:
(1) Thermoplastic layer of processing: thermoplastic layer is composed as followed:
Ethyl acetate: 50%˜60%
Thermoplastic rubber: 20%˜30%
Plasticizer: 10%
Processing agent: 10%, it will be blended by ratio and, made into liquid form after heating, furthermore, will be processed through the injection, the shape will then be obtained after cooling.
(2) Hot coating: It is orderly composed of polyethylene layer, thermoplastic layer, and surface-clothing layer, will process hot coating after heating at 100˜120° C. for 1 minute.
(3) Cooling: Thermoplastic Insole product will be obtained after cooling at 0-4° C. for 2 minutes.

4. The Thermoplastic Insole's Plasticized Method:
(1) Heating: To heat insole, and make it soft.
(2) Pressing: User applies foot as molding and, press on the insole as to obtain shape.
(3) Cooling: Cooling & Forming in room temperature.

5. The Thermoplastic Insole's Plasticized Method as claimed in claim 4, the heating method can adopt covering the insole by plastic film or plastic bag, then, dip it into 60° C.˜80° C. hot water.

6. The Thermoplastic Insole's Plasticized Method as claimed in claim 4, the heating method can be applied by oven.

7. The Thermoplastic Insole's Plasticized Method as claimed in claim 4, the heating method can be applied by microwave oven.
